(19) United States
(12) Patent Application Publication
(10) Pub. No.: US 2011/0226914 A1
(43) Pub. Date: Sep. 22, 2011

(54) COLLAPSIBLE SUPPORT STRUCTURE FOR A BAG

(75) Inventor: Kevin Fleming, Kansas City, MO (US)

(73) Assignee: Instabol LLC, Kansas City, MO (US)

(21) Appl. No.: 13/052,745

(22) Filed: Mar. 21, 2011

Related U.S. Application Data
(60) Provisional application No. 61/340,830, filed on Mar. 20, 2010.

(51) Int. Cl. B65B 67/12; B23P 11/00

(52) U.S. Cl. 248/99; 29/428

(57) ABSTRACT

The invention relates to a collapsible support structure for holding a bag and method for using the support structure to hold open a bag and create a semi-rigid container. In particular, the support structure is configured to hold open the mouth of a flexible plastic bag to facilitate filing the bag or removal of the contents of the bag. More particularly, the support structure is configured to create a skeleton that allows a flexible plastic bag to be converted into a container that stands upright with the mouth of the bag open allowing a user to easily add or remove contents from the flexible plastic bag.

### CROSS REFERENCE TO RELATED APPLICATION

This application claims priority from U.S. Provisional Application Ser. No. 61/340,830 filed on Mar. 20, 2010, which is hereby incorporated by reference in its entirety.

### FIELD OF INVENTION

The invention relates to a novel support structure for holding a bag and method for using the support structure to create a semi-rigid container. In particular, the support structure is configured to hold open the mouth of a flexible plastic bag to facilitate filing the bag or removal of the contents of the bag. More particularly, the support structure is collapsible and configured to create a skeleton that allows a flexible plastic bag to be converted into a container that stands upright with the mouth of the bag open allowing a user to easily add or remove contents from the flexible plastic bag.

### BACKGROUND

Plastic bags have numerous uses by consumers including as a storage container for food, liquids, toys, utensils, toiletries, almost anything imaginable. The use of resealable bags plastic bags offer a low cost alternative to other costly storage containers made out of rigid plastic, glass, or other material. The plastic bags provide an advantage over rigid containers for numerous reasons including saving storage space. The plastic bags take up minimal space when not in use and also take up the minimum space when filled with contents since removing extra air minimizes the total space requirement. The pliable and malleable nature of the plastic bag allows it to conform to numerous shapes and sizes when stored. Since the resealable bags come in several shapes and sizes with numerous varieties of volumes sizes ranging from sandwich, pint, quart, one gallon, two gallon, and larger sizes available for a consumer it is much easier for a consumer to choose a bag that specifically meets their needs.

Resealable plastic bags are a staple for people on the go. The convenience of putting a flexible container in a backpack or purse easily allows a user to carry a snack or other product while on the go. The flexibility of the bag allows it to conform to the available space in a backpack or purse instead of a bulky and inefficient rigid container. The discarding of the plastic bag after use also provides for easy cleanup which is important especially for consumers in a hurry.

One major drawback to using a plastic bag is the challenge of filing or removing contents from the bag especially when used with fluids, sauces, or other granular items. Because of the flexible and collapsible nature of the plastic bag the bag lacks the rigidity a hard plastic or glass container has which limits the bags ability to act as a vessel allowing a consumer to easily add or remove the contents. A consumer can use the plastic bag, for example, to transport food and water for a pet, but without a container to empty the contents in the bag is limited in its usefulness for only storage or transport.

Although the art has many examples of support structures for holding a plastic bag in an open position to facilitate filing these devices have many drawbacks and none adequately address the specific needs of users that allows easy of filing and also conversion to a semi rigid container for serving or removal of the contents. Thus, there is a long felt but unmet need for an apparatus that is designed to easily transform a plastic bag into a semi-rigid container that can easily be used with and removed from an empty or full bag. Also, a need exists for an apparatus designed to easily collapse to a flat orientation for easy storage and transportation. As will be described in greater detail, the support structure apparatus of the present invention differs from current products in the industry and allows a user to easily work with a flexible plastic bag to mimic the capabilities of a more rigid storage container without the limitations encountered when the rigid storage containers are used.

### SUMMARY OF THE INVENTION

This invention provides generally to a support structure for supporting a plastic bag and a method for creating a semi-rigid container. The support structure is configured for receiving and supporting a bag in an open position allowing a user to easily fill or remove contents from the bag. The tubular member includes a wall, top edge and bottom edge. The configuration of the tubular member and a first opening is designed to receive the bag.

A further object of the invention is to provide a support structure integrally attached to a bag. The support structure can be designed for incorporation into the wall of the bag to create a flexible bag that can transform to a semi-rigid container.

A further object of the invention is to provide a support structure that can be used with a bag to create a semi-rigid container for use by a consumer. The support structure is configured to receive the bag and act as a skeleton for shaping the bag into standing container. Further, the support structure is easily removed from contact with the bag when the consumer is ready to transport or store the bag for later use.

A further object is to provide a support structure that can be easily collapsed for flat storage when not in use.

A further object is to provide a support structure where the circumference of the top and/or bottom edge can be easily adjusted to expand or reduce the overall circumference of the top and/or bottom edge. Adjusting the circumference allows a user to use a single support structure with a variety of bag sizes.

Other objects of the present invention will become readily apparent upon reading the following detailed description in conjunction with the accompanying drawings and claims.

### BRIEF DESCRIPTION OF THE DRAWINGS

The accompanying drawings illustrate embodiments of the invention and are for illustration by way of example and not limitations.

FIG. 1 is a perspective view of the support structure.

FIG. 2a is a perspective view of the support structure partially folded.

FIGS. 2b and 2c our top views of the support structure partially folded.

FIG. 3a is a perspective top view of the support structure.

FIG. 3b is a perspective bottom view of the support structure.

FIGS. 4a and 4b is a top and bottom view of the support structure when configured in a conical shape.

FIGS. 4c and 4d are side views of the support structure.

FIG. 5a is a side view of one embodiment of the support structure folded.

FIG. 5b is a side view of another embodiment of the support structure folded.

FIG. 6 is a perspective view of a bag inserted into the support structure.

FIG. 7 is a perspective view of the support structure in use with the dotted lines representing a bag folded over the top edge of the support structure.

FIG. 8 is a perspective view of the adjustable support structure without the ends attached.

FIG. 9 is a bottom view of an embodiment of the support structure with a locking member.

### DETAILED DESCRIPTION OF THE INVENTION

The present invention relates to a support structure 10 for a bag as shown in FIGS. 1 and 7 and a method for using the support structure 10 to create a semi-rigid container.

The support structure 10 is fabricated using a lightweight durable and pliable material, which is preferably a plastic, but can be composed of any other material known in the industry that includes but is not limited to paper, cardboard, leather, cloth material, cork, neoprene, and combinations thereof. In another embodiment the support structure 10 can be made from a corrugated material such as cardboard or plastic to produce the desired support structure.

The support structure 10 is shown in multiple view in FIGS. 1, 2, 6, and 7 and is configured to support a plastic bag in an upright orientation with the open end of the bag 8 held open as shown in FIG. 7. The support structure 10 is generally configured as a tubular member 12 with an opening end 14.

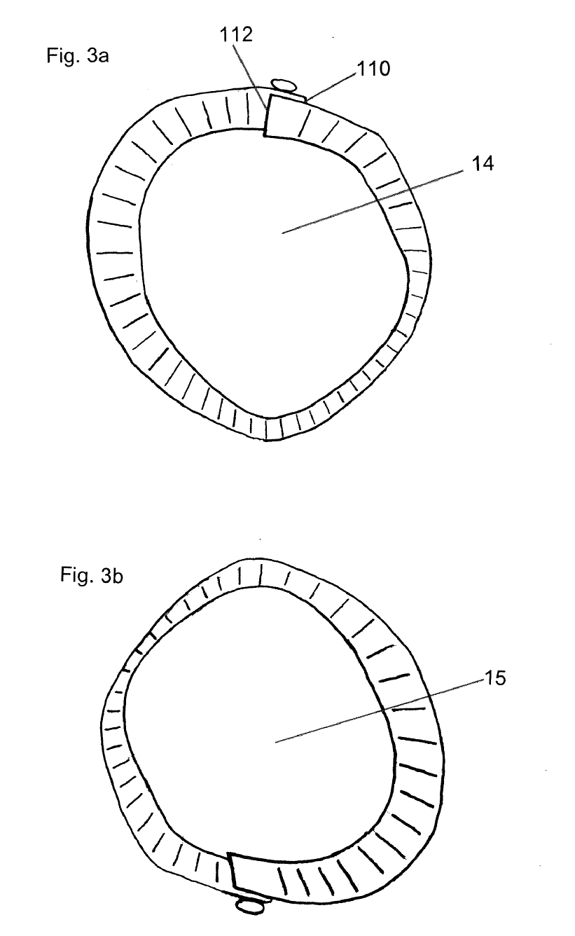

The body of the support structure 10 is shown in multiple views in FIGS. 1-8 and is configured as a tubular member 12 with a wall 16, an edge 18, and an opposite edge 20. The wall 16, edges 18 and 20 allow the support structure 10 to stand in an upright orientation when in use such as on a table or counter. In one embodiment the tubular member 12 is a single piece of material with no continuous break in the wall 16 along a longitudinal line from the edge 18 to the opposite edge 20. In another embodiment the tubular member 12 is a single piece of material that includes a break 108 along a longitudinal line perpendicular from the edge 18 to the opposite edge 20 creating a first end 110 and second end 112 as illustrated in FIG. 8. In another embodiment, the break 108 can be along a diagonal line not perpendicular from the edge 18 to the edge 20. As shown in FIG. 3, the ends 110 and 112 can communicate in an integral manner creating an integral attachment or in an alternative embodiment the ends 110 and 112 can communicate in a removeable manner creating a removeable attachment as illustrated in FIG. 8. The communication between the ends 110 and 112 can include an attachment member 114 including any means known in the art for attachment that is either removable or integral, including but not limited to snaps, buttons, hook and loop, rivets, adhesives, plastic welds and combinations thereof.

In another embodiment, the tubular member 12 including the edges 18 and 20 can be configured to be adjustable. The adjustable nature of the tubular member 12 allows the circumference of the edges 18 and 20 to be expanded or reduced dependent on the type of bag used with the support structure 10. The ends 110 and 112 are configured to adjust along the wall 16 of the tubular member 12 to expand or reduce the edges 18 and 20 circumference. The attachment member(s) 114 are configured along the wall of the tubular member 12 to aide in the connection and adjustment between the ends 110 and 112 to create the tubular member 12 when engaged. Allowing the tubular member 12 to adjust in size permits the tubular member to better communicate with and fit more securely around the perimeter of the bag in use. Adjusting the circumference size of the support structure 10 also allows a single support structure to be used with bags of varying size including but not limited to sandwich, quart, gallon, two gallon and any size used by a consumer.

The tubular member 12 is generally a circular shape but can also include square, rectangular, triangle, star-shaped, oval, polygonal, hexagonal, pentagonal, octagonal, or any shape that could accommodate a flexible bag 8, such as a resealable plastic bag or any bag used in the industry for storage.

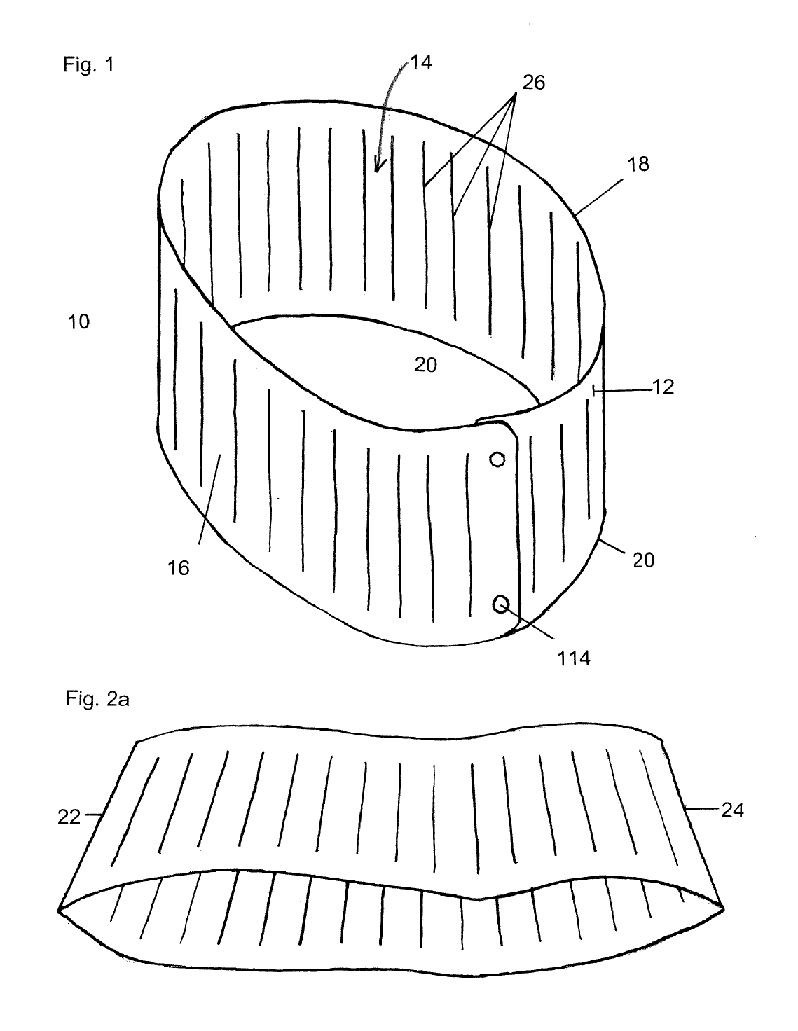

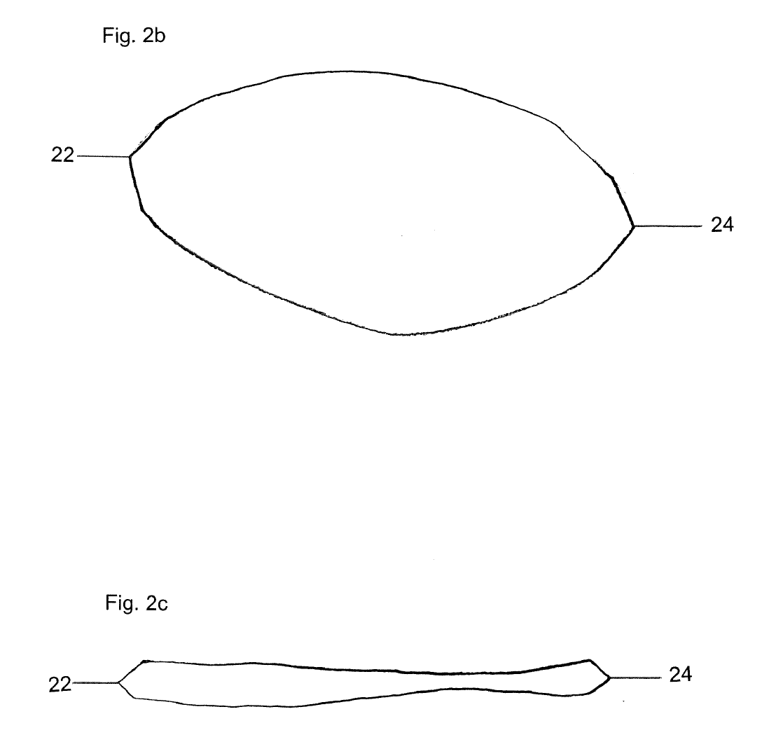

In another embodiment the tubular member 12 will include a fold line 22 as illustrated in FIG. 2a-c. The fold line 22 is configured in a longitudinal orientation from the edge 18 to the opposite edge 20. In a preferred embodiment tubular member 12 will include two fold lines 22 and 24 positioned 180° degrees apart on the resulting circumference of the open tubular member. In another embodiment, the fold line 22 is perpendicular to the edges 18 and 20. In another embodiment, the fold line 22 is not perpendicular to the edges 18 and 20 and can run in a diagonal orientation from the edges 18 and 20. The fold line 22 and 24 creates folding axes allowing the tubular member 12 to fold flat or open to a conical configuration for use. In another embodiment the tubular member 12 can include a varied number of fold lines dependent on the desired configuration. The number of fold lines 22 can include but are not limited to 3, 4, 5, 6, 7, 8, 9, 10, 11, 12, 13, 14, 15, 16, 17, 18, 19, 20, or more fold lines. In the preferred embodiment the fold lines 22 are living hinges integrated into the material for the tubular member. The fold lines 22 can also be of any means known in the industry that will allow flexibility of the material including folding of the material but not limited to a hinge, perforation of the material, or combinations thereof. In another embodiment, the fold line 22 can be configured in a longitudinal orientation within the wall of the tubular member, but may not extended from the edge 18 to the opposite edge 20, but instead is contained within but not touching the edge 18 or opposite edge 20.

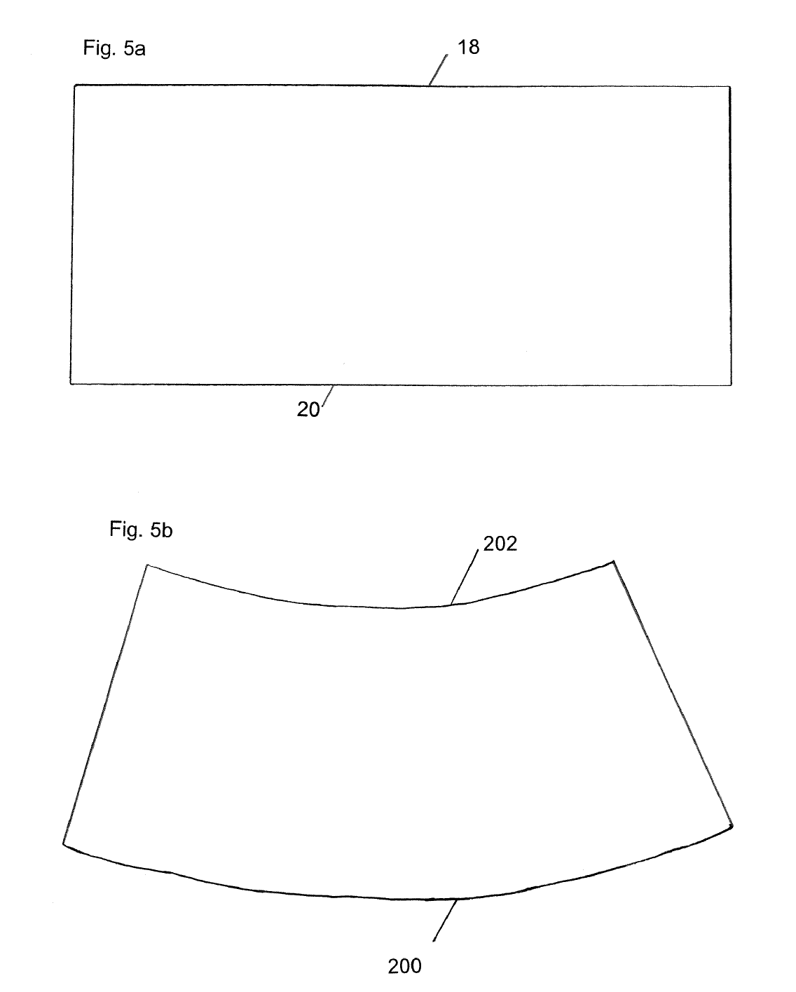

In one embodiment, the tubular member 12 is configured with the fold lines 22 and 24 to allow the tubular member 12 to fold in a flat orientation. When the tubular member 12 is folded the edge 18 and opposite edge 20 are configured in a flat orientation as shown in FIG. 5a. In another embodiment, the tubular member 12 when folded creates a concave edge 200 and convex opposite edge 202 as shown in FIG. 5b. In both embodiments the tubular member 12 when opened creates a general conical configuration as shown in FIGS. 1, 3, 4, and 7.

In another embodiment, the tubular member 12 is configured without fold lines 22. The support structure 10 can be composed of flexible material that does not require fold lines for it to lay in a flat orientation when not in use.

FIG. 1 illustrates an embodiment that includes at least a slit 26 in a longitudinal orientation. The tubular member 12 can include more than one slit 26 with the slits 26 parallel to each other and in a perpendicular orientation to the edge 18 along a longitudinal orientation around the tubular member 12. In another embodiment, the tubular member 12 can include a plurality of slits 26. The slit(s) 26 are configured to help with the flexibility and collapsibility of the support structure 10. In another embodiment the tubular member 12 can be configured with no slits dependent on the material used to create the support structure as illustrated in FIG. 5.

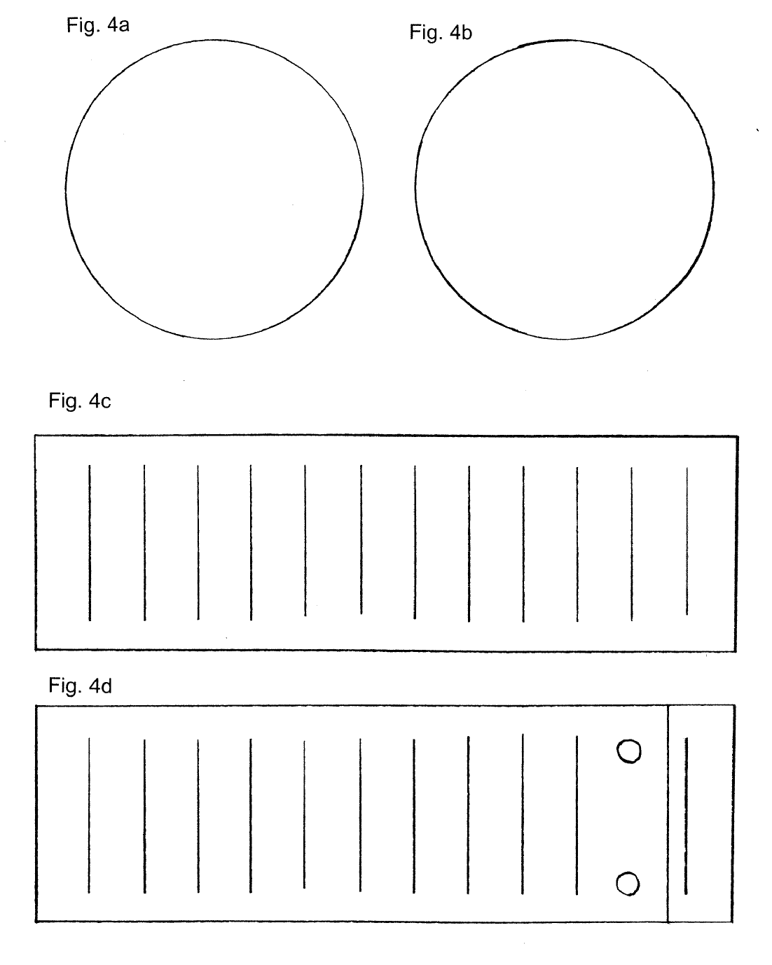

The tubular member 12 further comprises a first opening 14 as shown in FIG. 3. The first opening is configured as the area within the circumference of the edge 18. The first opening 14 is configured to receive the plastic bag 8. In one embodiment the tubular member 12 further includes a second opening 15 as shown in FIG. 4. The second opening 15 is parallel to the first opening and includes the area within the circumference of the opposite edge 20.

In the preferred embodiment the circumference of the edge 18 for the first opening 14 and the circumference for the opposite edge 20 for the second opening 15 are both equal. In this configuration the tubular member 12 has two parallel and of equal circumference first and second openings. In another embodiment, the circumference of the edge 18 for the first opening 14 and the circumference for the opposite edge 20 for the second opening 15 are unequal. In this configuration the tubular member 12 has two parallel but unequal circumference first and second openings, creating a typical bowl type structure with a larger circumference edge on the top a smaller circumference edge on the bottom.

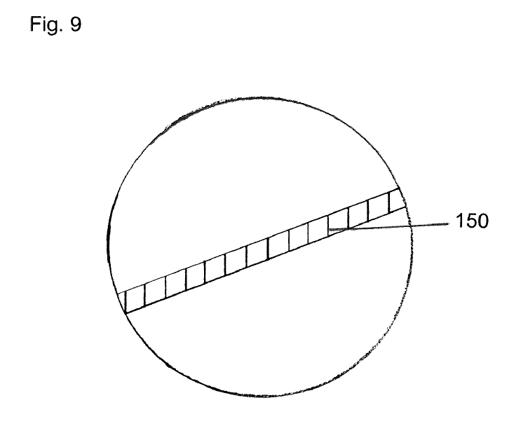

The support structure 10 may also include a locking member 150 configured to aide in holding open the tubular member 12 as illustrated in FIG. 9. The locking member 150 is configured to communicate with the tubular member either via an edge 18 or 20 or the internal side wall of the tubular member 12. The locking member 150 can be any configuration known in the industry for holding open a conical configuration, and can further include a locking mechanism.

The support structure 10 is designed for use with a bag 8. The bag can include any bag used by consumers for storage or used in the industry for packaging products, such as but not limited to consumer goods. The support structure 10 is configured to communicate with the bag 8 to create the semi-rigid container, but the support structure can be removed when not in use and the bag is ready to store. In another embodiment, the support structure 10 can be incorporated into the design of the bag 8 to create a bag 10 with an integrally configured support structure.

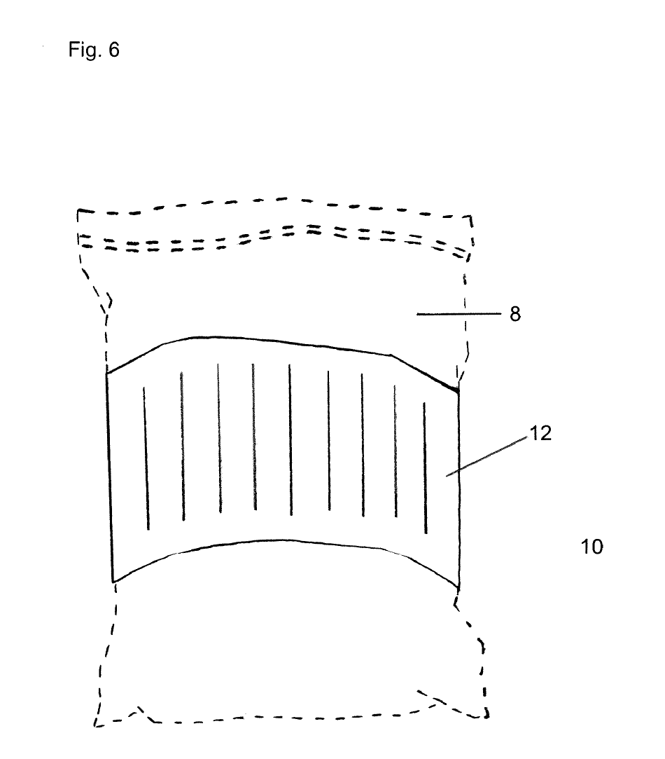

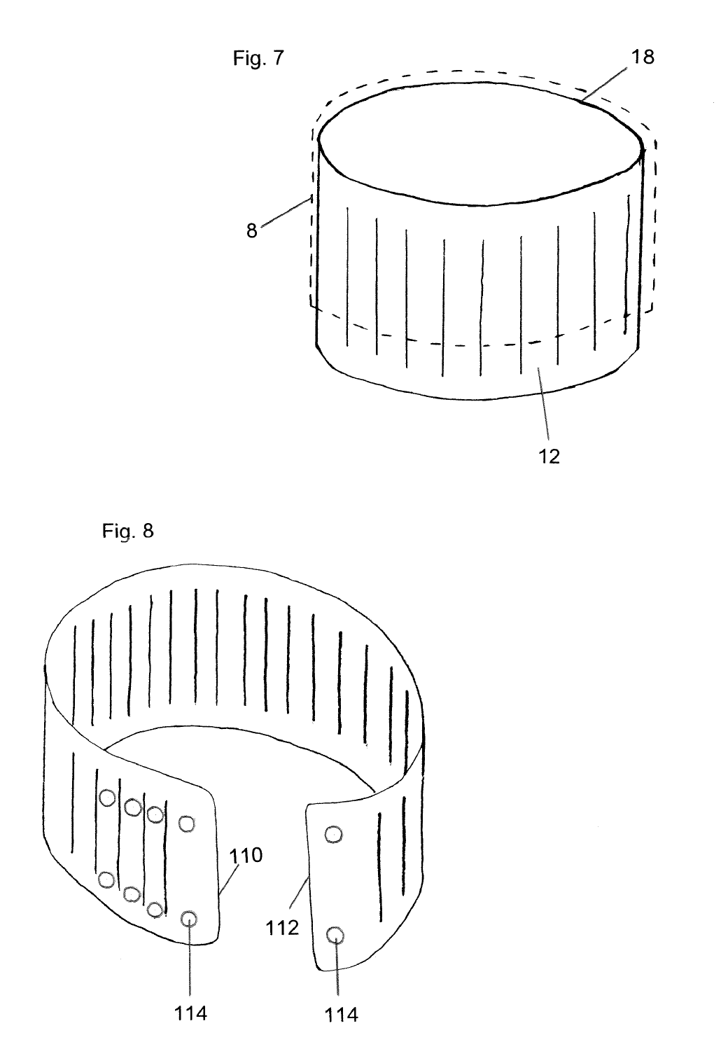

The method for using the support structure is also disclosed. The method generally includes using the support structure 10 with a bag 8 to create a semi-rigid container. A resealable plastic bag 8 is illustrated in FIGS. 6-7 to provide an illustration of how the support structure is designed to work with a bag. The support structure 10 is first unfolded to create an open tubular member 12 with a first opening 14 on the edge 18. The bag 8 is inserted within the support structure 10. The support structure 10 acts as a sleeve when inserted over the bag 8 as illustrated in FIG. 6. Next a user folds the open end of the bag 8 over the edge 18 and around the tubular member 12. Folding the bag 8 over the tubular member 12 creates the semi-rigid container that permits the bag to remain open allowing a user to fill the bag or remove the contents from the bag without the user continually holding or supporting the bag 8. In another embodiment, the support structure 10 can be designed for incorporation into the bag 8 design to create bag 8 with an integrally attached support structure 10.

Thus, there has been described a support structure for a bag and a method for using. It is apparent to those skilled in the art, however, that many changes, variations, modifications, other uses, and applications to the support structure method for using are possible, and also such changes, variations, modifications, other uses, and applications which do not depart from the spirit and scope of the invention are deemed to be covered by the invention, which is limited only by the claims which follow.

What is claimed is:

1. A support structure for a bag comprising:
a. a tubular member comprising at least two folding axes for collapsing the tubular member into a flattened orientation; and,
b. at least a first opening end for receiving and retaining a bag.

2. The support structure of claim 1, further comprising a second opening end and wherein the first and second opening ends are circular.

3. The support structure of claim 1, wherein the tubular member further comprises a wall with a top edge and bottom edge.

4. The support structure of claim 1, wherein the folding axes are living hinges configured within a longitudinal line from the first opening end to the second opening end.

5. The support structure of claim 1, wherein the tubular member further comprises at least one slit within the wall of the tubular member.

6. The support structure of claim 1, wherein the tubular member further comprises a break along a longitudinal line from the first opening end to the second opening end creating a first end and a second end.

7. The support structure of claim 6, wherein the first and second ends are removably attached, wherein permitting the tubular member to flatten when the first and second ends are disengaged or to create the tubular member when engaged.

8. The support structure of claim 7, wherein the support structure includes an attachment member configured to allow communication between the first and second ends to create the tubular member when engaged.

9. The support structure of claim 6, wherein the first and second ends are integrally attached.

10. The support structure of claim 1, wherein the first opening end of the tubular member is adjustable, wherein permitting the circumference of the first opening end to be adjustable.

11. The support structure of claim 1, wherein the at least one slit is configured within a longitudinal line from the first opening end to the second opening end, but does not contact the first opening end or second opening end.

12. The support structure of claim 1, wherein the support structure further comprises a locking member configured to hold the tubular member in an unfolded position, wherein the holding arm further includes a locking mechanism.

13. The support structure of claim 1, wherein the first opening end and second opening end are equal in circumference.

14. The support structure of claim 1, wherein the support structure is integrally attached to or incorporated into the bag.

15. A collapsible support structure for a bag comprising:
a. A tubular member comprising a first and second opening, at least two folding axes for permitting the tubular member to fold into a flattened condition; and a plurality of folding members configured in the wall of the tubular member positioned perpendicular from the first opening to the second opening, wherein the folding members are selected from the group consisting of living hinges, slits, and combinations thereof.

16. The support structure of claim 15, wherein the first opening and second open are unequal in circumference, and wherein tubular member comprises a convex shape along a top edge portion and a concave shape along a bottom edge portion when disposed in a flattened condition.

17. A support structure for a bag comprising:
a. A tubular member composed of a semi-rigid flexible material allowing the tubular member to fold along a longitudinal line into a flattened orientation;
b. A first opening end for receiving and retaining a bag; and,
c. A second opening.

18. A method for creating a semi-rigid container comprising:
a. unfolding a support structure that is configured with at least two folding axes to form a tubular member with a first opening and second opening;
b. inserting one end of a bag into the first opening of the tubular member wherein filling the space within the tubular member; and,
c. opening the second end of the bag and folding the open second end over the edge of the tubular member.
